(19) United States
(12) Patent Application Publication
(10) Pub. No.: US 2019/0170542 A1
(43) Pub. Date: Jun. 6, 2019

(54) OPTICAL STRUCTURE FOR ROTATION POSITIONING

(71) Applicant: PixArt Imaging Inc., Hsin-Chu County (TW)

(72) Inventors: CHUNG-TING YANG, Hsin-Chu County (TW); KAI-HO TSAI, Hsin-Chu County (TW); SHIH-KUAN LIU, Hsin-Chu County (TW)

(21) Appl. No.: 15/939,523

(22) Filed: Mar. 29, 2018

(30) Foreign Application Priority Data
Dec. 1, 2017 (TW) 106142281

(51) Int. Cl. G01D 5/347; G01D 18/00

(52) U.S. Cl. CPC G01D 5/34707; G01D 18/00; G01D 5/3473

(57) ABSTRACT

The present disclosure is related a technology of confirming a position using an optical sensor to detect reflected light coming through a through hole formed at a predetermined position on a rotation device. In the present disclosure, the optical sensor and a light source are formed at the same side of a rotatable element so as to reduce the occupied space and simplify the manufacturing process.

### CROSS REFERENCE TO RELATED APPLICATION

This application claims the priority benefit of Taiwan Patent Application Serial Number 106142281, filed on Dec. 1, 2017, the full disclosure of which is incorporated herein by reference.

### BACKGROUND

### 1. Field of the Disclosure

This disclosure generally relates to an optical structure for positioning a rotatable device and, more particularly, to a technology of confirming a position using an optical sensor to detect reflected light coming through a through hole formed at a predetermined position on the rotatable device.

### 2. Description of the Related Art

Conventionally, in order to position a rotatable device, “opposite type” optical sensing mechanism is adopted in which a light source and an optical sensor are arranged at two opposite sides of the rotatable device. The light source is positioned opposite to the optical sensor, and the rotatable device is formed with an aperture for light going through. When the aperture is rotated to be between the light source and the optical sensor, the light from the light source penetrates the aperture and is sensed by the optical sensor. In this way, a position of the rotatable device is confirmed.

However, in this kind of mechanism, because the light source and the optical sensor are arranged at two sides of the rotatable device, the control circuits thereof also have to be laid at two sides of the rotatable device such that the manufacturing complexity and the occupied space are increased. Meanwhile, in the arrangement of the light source, the optical sensor and the rotatable device, the exact positional relationship between the three has to be considered which also increases the manufacturing complexity.

### SUMMARY

The present disclosure provides an optical structure for positioning a rotatable device. It is an object of the present disclosure to arrange an optical sensor and a light source at the same side of the rotatable device. Using the geometric arrangement, the optical sensor is able to receive reflected light generated by the light source only at a predetermined positioning location. To achieve this object, the optical sensor and the light source are arranged very close to the rotatable device, and at least one through hole is formed on the rotatable device. In this way, if the through hole is not aligned with the light source, light generated by the light source is blocked by a plane opposite to the light source and the optical sensor to cause the light to be reflected immediately after being emitted such that the optical sensor is not able to detect the emitted light.

When the through hole is aligned with the light source, light emitted by the light source goes through the through hole and is reflected by another object behind the through hole. In this case, as the light propagates through a longer path, reflected light has a larger emission range and is detectable by the optical sensor. It should be noted that the light source and the optical sensor are arranged symmetrical to a reflection point (e.g., the optical sensor being arranged at a main reflection path) or not. When the emitted light impinges on the object, in addition to the symmetrical reflected light (e.g., light on the main reflection path), other scattered light (e.g., light not on the main reflection path) is also generated. Because the scattered light has a wider reflected direction, the optical sensor still detects reflected light even though the optical sensor and the light source are not arranged symmetrically corresponding to the reflection point.

The present disclosure provides an optical structure for rotation positioning. The optical structure includes at least one rotatable element, a reflection object, a light source and an optical sensor. Each of the at least one rotatable element has at least one through hole. The reflection object is arranged at one side of the at least one rotatable element. The light source is arranged at the other side of the at least one rotatable element, and configured to emit light toward the at least one rotatable element, wherein when the at least one rotatable element is rotated to a predetermined position, emitted light of the light source goes through the at least one through hole and projects on the reflection object. The optical sensor is arranged at the same side of the at least one rotatable element with the light source, and configured to receive reflected light from the reflection object.

The present disclosure further provides an optical structure for rotation positioning. The optical structure includes a rotatable element, a reflection object and a control chip. The rotatable element has at least one through hole. The reflection object is arranged at one side of the rotatable element. The control chip is arranged at the other side of the rotatable element and includes a light source, an optical sensor and a digital signal processor. The light source is configured to emit light toward the rotatable element, wherein when the rotatable element is rotated to a predetermined position, emitted light of the light source goes through the at least one through hole and projects on the reflection object. The optical sensor is configured to convert reflected light from the reflection object to electrical signals. The digital signal processor is configured to position the rotatable element according to the electrical signals.

### BRIEF DESCRIPTION OF THE DRAWINGS

Other objects, advantages, and novel features of the present disclosure will become more apparent from the following detailed description when taken in conjunction with the accompanying drawings.

FIG. 1 is a cross sectional view of an optical structure according to a first embodiment of the present disclosure.

FIG. 2 is a second embodiment of the present disclosure which has multiple rotatable elements.

FIG. 3 is a third embodiment of the present disclosure, in which multiple through holes are formed at different positions of a rotatable element.

FIG. 4 is a cross sectional view of an optical structure according to a fourth embodiment of the present disclosure.

FIG. 5 is a cross sectional view of an optical structure according to a fifth embodiment of the present disclosure.

### DETAILED DESCRIPTION OF THE EMBODIMENT

It should be noted that, wherever possible, the same reference numbers will be used throughout the drawings to refer to the same or like parts.

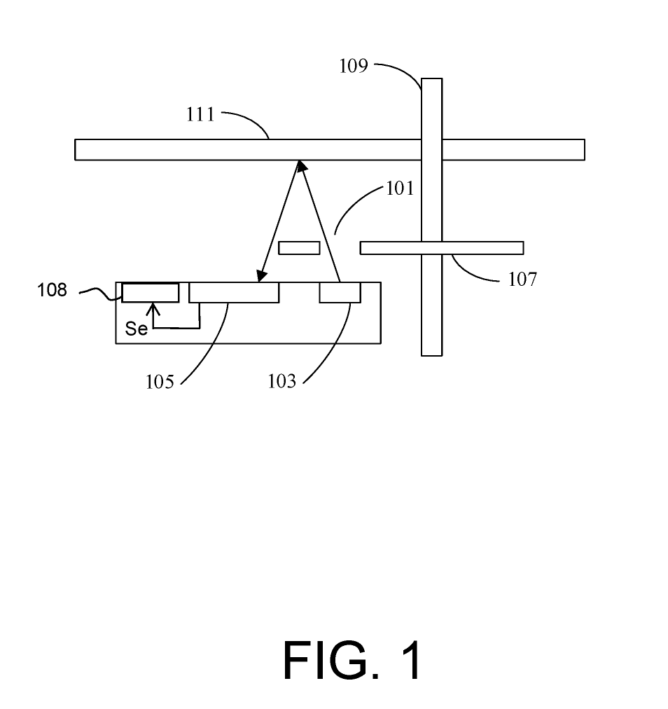

Referring to FIG. 1, it is a cross sectional view of a first embodiment of the present disclosure. In FIG. 1, the rotatable device is shown to have at least one plane, e.g., a rotatable plane 107. At least one through hole (e.g., one through hole 101 being shown in FIG. 1) is formed on the rotatable plane 107 to allow light emitted by a light source 103 to go through. The emitted light illuminates an object 111 (preferable a reflection object) at the other side of the rotatable plane 107 and reflected light is generated. The optical sensor 105 detects the reflected light and generates electrical signals Se by optical sensing. The electrical signals Se are used to indicate whether the rotatable plane 107 is rotated to a predetermined position. The rotatable plane 107 rotates by a shaft 109.

In a non-limiting embodiment, at least one of the rotatable plane 107 and the object 111 is a gear, and the shaft 109 is a gear shaft. The shaft 109 is driven by a motor to rotate at least one of the rotatable plane 107 and the object 111 at a predetermined rotating speed.

In this embodiment, a diameter of the through hole 101 is not a limitation of the present disclosure. As long as the light can go through, even a tiny hole is adaptable to the present disclosure. In order to cause the optical sensor 105 not to detect reflected light when the thorough hole 101 is not aligned with the light source 103, a space between the rotatable plane 107 and the light source 103 should be very small, preferably smaller than 0.2 mm to block the propagation of light therebetween. In this way, if the through hole 101 does not pass the above space of the light source 103, the reflected light is not detected by the optical sensor 105.

It should be mentioned that said through hole 101 being aligned with the light source 103 (i.e. rotating to a predetermined position) is not limited to that the through hole 101 is right above the light source 103. According to an emission direction of the light source 103, the through hole 101 is arranged to deviate toward the optical sensor 105. More specifically, in the present disclosure, when the rotatable plane 107 is rotated to the predetermined position, the at least one through hole is right above the light source 103, or between upper space of the light source 103 and the optical sensor 105.

For example, FIG. 1 shows that the optical sensor 105 is arranged outside an edge of the rotatable plane 107, and thus the optical sensor 105 does not receive reflected light (referred to the light after being reflected by the object 111) from the object 111 via the at least one through hole 101. In an embodiment having a larger through hole that exposes a part of the light source 103 and a part of the optical sensor 105, the optical sensor 105 is arranged under the rotatable plane 107. The positional relationship between the light source 103, the optical sensor 105 and the object 111 is arranged flexibly as long as the optical sensor 105 detects light reflected by the object 111.

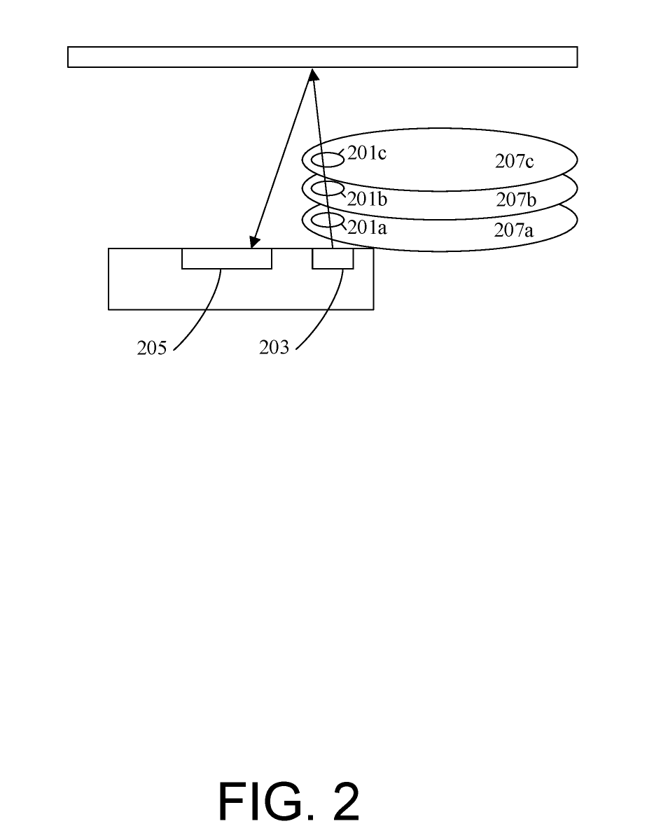

FIG. 2 is a second embodiment of the present disclosure, and a difference thereof from the first embodiment is that multiple rotatable planes 207a, 207b and 207c are shown in FIG. 2, and at least on through hole is formed on each rotatable plane (FIG. 2 showing one through hole on each rotatable plane). In this embodiment, light emitted by the light source 203 penetrates the through holes 201a, 201b and 201c when these through holes are aligned to allow the optical sensor 205 to detect the reflected light. That is, the rotatable planes 207a, 207b and 207c are all rotated to a predetermined position and the positioning is accomplished. In this embodiment, as long as the multiple through holes have an overlapped area, the light source can go through, and this is one benefit of the optical detection. As the through hole for the light penetration does not have the volume limitation, high accuracy is not extremely required in manufacturing these through holes.

Furthermore, the rotatable plane 207a is the first plane to limit the propagation of emitted light, and thus the rotatable plane 207a should be arranged very close to the light source 203 as mentioned in the first embodiment.

In a non-limiting embodiment, the rotatable planes 207a, 207b and 207c have different sizes, radiuses and/or rotating speeds. Every a predetermined time interval, the through holes 201a, 201b and 201c overlap once to allow the light emitted by the light source 203 to go through every through hole 201a, 201b and 201c to be reflected by the above object.

In a non-limiting embodiment, the optical sensor 205 has a sensing array. When the light emitted by the light source 203 goes through the through hole 201a but is unable to pass the through hole 201b and is reflected by the rotatable plane 207b (e.g., a lower surface thereof), a light spot is formed at a first location of the sensing array. When the light emitted by the light source 203 goes through the through holes 201a and 201b but is unable to pass the through hole 201c and is reflected by the rotatable plane 207c (e.g., a lower surface thereof), a light spot is formed at a second location (different from the first location) of the sensing array. When the light emitted by the light source 203 goes through the through holes 201a, 201b and 201c and is reflected by the above object, a light spot is formed at a third location (different from the first and second locations) of the sensing array. Accordingly, a processing unit (e.g., a digital signal processor) identifies positions of the rotatable planes 207a, 207b and 207c according to a location of the light spot in the image frame outputted by the sensing array.

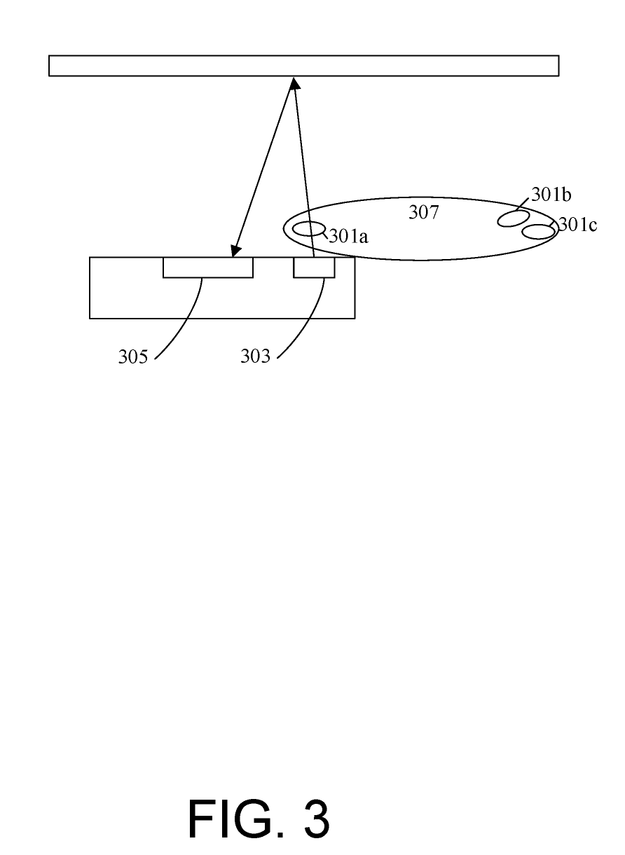

FIG. 3 is a third embodiment of the present disclosure, and a difference thereof from the first embodiment is that multiple through holes 301a, 301b and 301c arranged with a predetermined relative distance from one another are formed at different positions on a same rotatable plane 307. The space between the multiple through holes is used to locate different positions of the rotatable plane 307. For example in this embodiment, the through hole 301b is very close to the through hole 301c. Accordingly, when the rotatable plane 307 is rotating, and if the optical sensor 305 successively receives reflected light having a magnitude larger than a threshold twice (within a predetermined time interval), it means that the rotatable plane 307 is rotated to a position of the through hole 301b or 301c depending on the rotating direction. However, when the rotatable plane 307 is rotating, and if the optical sensor 305 receives reflected light having a magnitude larger than a threshold once, it means that the rotatable plane 307 is rotated to a position of the through hole 301a.

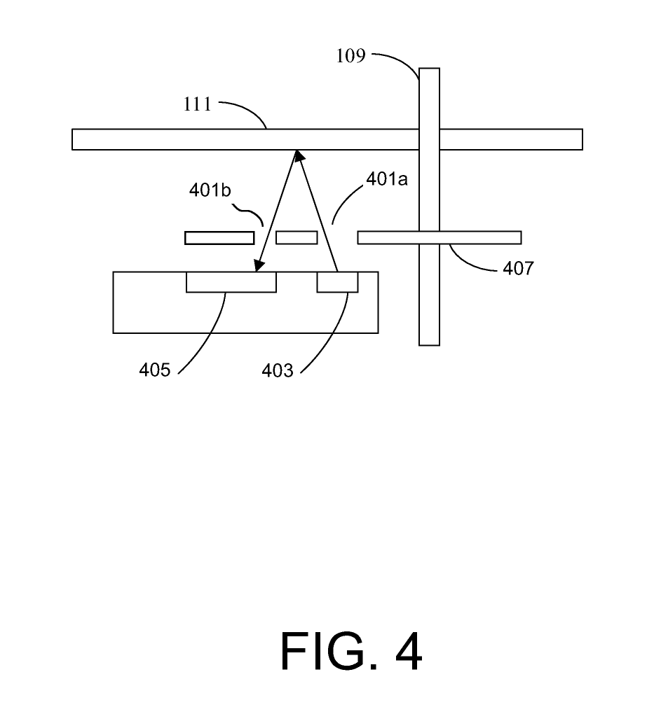

FIG. 4 is a cross sectional view of a fourth embodiment of the present disclosure, which shows two through holes 401a and 401b are formed on one rotatable plane 407. The first through hole 401a allows the emitted light of the light source 403 to go through to reach the above object 111. The second through hole 401b allows the reflected light to go through to impinge on the optical sensor 405. The first through hole 401a and the second through hole 401b have identical or different sizes and/or shapes without particular limitations as long as when the light source 403 and the optical sensor 405 are aligned with the first and second through holes 401a and 401b respectively, the emitted light from the light source 403 is reflected by the object 111 and then received by the optical sensor 405. As mentioned above, the rotatable plane 407 is very close to the light source 403 and the optical sensor 405.

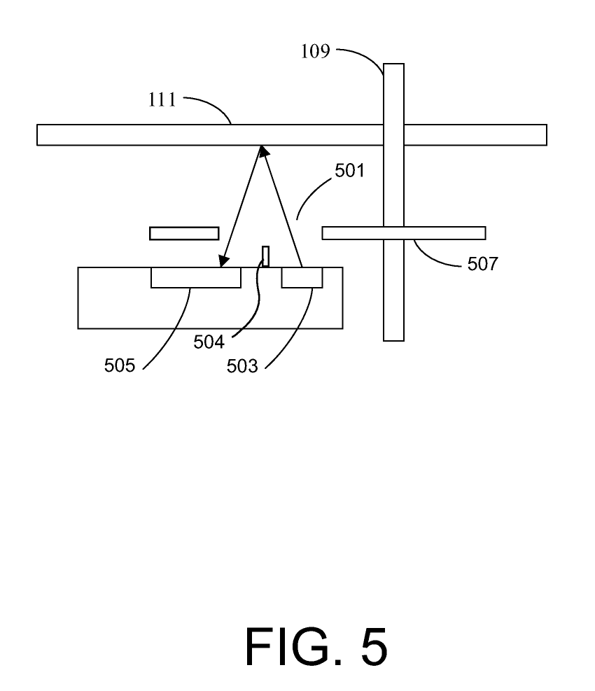

FIG. 5 is a cross sectional view of a fifth embodiment of the present disclosure, which shows that a rotatable plane 507 has a single large through hole 501 to allow the emitted light of the light source 503 and the reflected light from the above object 111 to go through the same through hole 501. As mentioned above, the rotatable plane 507 is very close to the light source 503 and the optical sensor 505.

As mentioned above, according to the spatial arrangement of the light source 503, the through hole 501 and the optical sensor 505, the through hole 501 is located above a part or the whole of the light source 503 and the optical sensor 505, or located between upper space of the light source 503 and the optical sensor 505 when the rotatable plane 507 is rotated to the predetermined position.

In this embodiment, in order to prevent the emitted light of the light source 503 from being directly received by the optical sensor 505, preferably an opaque light blocking wall 504 is disposed between the light source 503 and the optical sensor 505.

In a non-limiting embodiment, the above light sources 103-503 are light emitting diodes or laser diodes that emit light of an identifiable spectrum, e.g., infrared light and/or red light. The optical sensors 105-505 are CMOS image sensors, photodiodes or other sensors for sensing light energy. The light sources 103-503 and optical sensors 105-505 are integrated in a control chip with a digital signal processor 108 (referring to FIG. 1), and the control chip and the object 111 are arranged at different sides of a rotatable plane, wherein the digital signal processor 108 is used to control the light sources 103-503 to emit light and control the optical sensors 105-505 to detect light, which is converted to electrical signals, corresponding to light emission of the light sources 103-503.

In other words, in the present disclosure the reflection object is arranged at one side of at least one rotatable plane (as shown in FIGS. 1-5), and the light source and optical sensor are located at the other side of the at least one rotatable plane. The light source is used to emit light toward the at least one rotatable plane. When the at least one rotatable plane is rotated to a predetermined position, emitted light of the light source goes through at least one through hole to project on the reflection object. The optical sensor is used to receive reflected light from the reflection object.

In a non-limiting embodiment, the digital signal processor identifying whether the alignment is fulfilled is to, for example, calculate a magnitude of the electrical signal and compares the calculated amplitude with a threshold. When the amplitude exceeds the threshold, the through hole of the rotatable plane 107-507 is identified to be aligned with the light source and/or the optical sensor which is referred as positioning the rotatable plane herein. For example, in FIGS. 1 and 2, the digital signal processor 108 compares the amplitude of the electrical signals with a threshold to position the rotatable plane 107, 207a-207c. For example in FIG. 3, the digital signal processor 108 positions the rotatable plane 307 according to a number of times of the amplitude variation of the electrical signals. As mentioned above, the amplitude is larger than the threshold for once when the rotation position is corresponded to the through hole 301a, and the amplitude is larger than the threshold for twice within a predetermined time interval when the rotation position is corresponded to the through holes 301b and 301c.

In a non-limiting embodiment, the digital signal processor 108 further controls the light source 103-503 to turn on and turn off, and controls the optical sensor 105-505 to acquire a bright image when the light source is turned on and acquire a dark image when the light source is turned off. Then the digital signal processor 108 calculates a differential image between the bright image and the dark image, and identifies whether the rotatable plane is rotated to the predetermined position according to a comparison result by comparing an amplitude of the differential image with the threshold to further improve the detection accuracy.

In the above embodiments, to specify the light of the light source, a filter is formed on the optical sensor or in the through hole such that only the light of a specific wavelength is detectable thereby improving the sensing efficiency.

The present disclosure is adaptable to set time of a watch (e.g., a satellite watch or GPS watch). When the watch receives a correct time signal (e.g., the watch having a communication interface for communicating with a station), hour and minute hands of the watch are moved to correct positions by using the present disclosure to accomplish the time setting. In addition, the present disclosure is further adaptable to an instrument panel using a spinning indicator or setting a gear to an original position, e.g., the panel for indicating flow rate and used electricity or the conveyor system for conveying goods by rotating gears.

Referring to FIG. 1 again, for example when the watch, which includes the optical structure in FIGS. 1-5, receives the correct time signal, the shaft 109 is controlled by a motor (not shown) to rotate the rotatable plane 107 to cause the through hole 101 to be aligned with the light source 103, i.e., controlling the rotatable plane 107 to be rotated to a calibration position according to the correct time signal. In some conditions, the rotatable plane 107 is not rotated to a correct calibration positon (i.e. the predetermined position) due to some problems when the watch receives the correct time signal. In this case, the digital signal processor 107 is further used to identify whether the amplitude of the electrical signal exceeds the threshold when the rotatable plane 107 is rotated to the calibration position in order to identify whether the calibration position is identical to the predetermined position or not.

When the amplitude of the electrical signal does not exceed the threshold, the control chip continuously rotates the rotatable plane 107 and counts a time interval to a next time that the through hole 101 is aligned with the light source 103 (e.g., using a counter to count a time interval before the amplitude of the electrical signal exceeding the threshold next time) so as to obtain a deviation angle of the rotatable plane 107. The deviation angle is stored in a memory (also in the control chip) as a calibration amount. In this way, when the watch receives the correct time signal again, the motor rotates the rotatable plane 107 to the calibration position plus or minus the calibration amount to cause the through hole 101 of the rotatable plane 107 to be correctly aligned with the light source 103. The process of storing the calibration amount is implemented by software and/or hardware codes in a calibration mode, which is entered by pressing a button or via a selection menu by a user.

In a non-limiting embodiment, a surface of the rotatable plane 107 facing the light source 103 and the optical component 105 is covered with light absorbing material such that when the through hole 101 is not aligned with the light source 103, the reflection is reduced to lower the noise.

In a non-limiting embodiment, a surface of the object 111 facing the light source 103 and the optical sensor 105 is covered with light reflective material (especially for reflecting the emitted light of the light source 103) to improve the reflection efficiency.

In a non-limiting embodiment, a light reflecting structure (e.g., a mirror) for directing reflected light to a specific direction (e.g., a direction to the optical sensor 105) is arranged on a surface of the object 111 facing the light source 103 and the optical sensor 105 so as to arrange the relative position of the light source 103 and the optical sensor 105 according to different requirements.

In a non-limiting embodiment, positions of the light source 103 and the optical sensor 105 in FIG. 1 are exchanged such that the optical sensor 105 receives reflected light from the object 111 only when the through hole 101 is aligned with the optical sensor 105. In this embodiment, the light source 103 emits light continuously, and preferably an upper surface of the rotatable plane 107 is covered with light absorbing material such that when the through hole 101 is not aligned with the optical sensor 105, the light emitted by the light source 103 is absorbed to reduce the interference.

In a non-limiting embodiment, the optical structure in FIG. 1 includes multiple light sources each being associated with a through hole, and each through hole has a corresponding optical sensor. The digital signal processor identifies the rotation position (or rotation angle) according to the sensing results of different optical sensors.

It should be mentioned that every non-limiting embodiment illustrated above using FIG. 1 as an example is also adaptable to FIGS. 2-5.

In addition, although the rotatable plane mentioned above is described by a plane, the present disclosure is not limited thereto. The rotatable plane is a suitable rotatable element (e.g., a gear), a part surface of which is a flat surface formed with other structures protruding or recessing from the flat surface as long as the structures do not influence the rotation thereof.

As mentioned above, the conventional positioning optical structure has a problem of high manufacturing complexity. Accordingly, the present further provides an optical structure for rotation positioning (e.g., FIGS. 1-5) in which a control chip, which includes a light source and an optical sensor, is arranged at a single side of the rotatable element so as to reduce the manufacturing complexity and the occupied space.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. An optical structure for rotation positioning, the optical structure comprising:
at least one rotatable element each having at least one through hole;
a reflection object arranged at one side of the at least one rotatable element;
a light source arranged at the other side of the at least one rotatable element, and configured to emit light toward the at least one rotatable element, wherein when the at least one rotatable element is rotated to a predetermined position, emitted light of the light source goes through the at least one through hole and projects on the reflection object; and
an optical sensor arranged at the same side of the at least one rotatable element with the light source, and configured to receive reflected light from the reflection object.

2. The optical structure as claimed in claim 1, wherein when the at least one rotatable element is rotated to the predetermined position, the at least one through hole is right above the light source.

3. The optical structure as claimed in claim 1, wherein when the at least one rotatable element is rotated to the predetermined position, the at least one through hole is between the light source and the optical sensor.

4. The optical structure as claimed in claim 1, wherein the light source and the optical sensor are integrated in a same control chip.

5. The optical structure as claimed in claim 1, wherein the optical structure has a single rotatable element which has multiple through holes arranged with a predetermined relative distance from one another.

6. The optical structure as claimed in claim 1, wherein the optical sensor is not configured to receive the reflected light via the at least one through hole.

7. The optical structure as claimed in claim 1, wherein the emitted light goes through a first through hole, and the reflected light goes through a second through hole which is different from the first through hole.

8. The optical structure as claimed in claim 1, wherein the emitted light and the reflected light go through an identical through hole.

9. An optical structure for rotation positioning, the optical structure comprising:
a rotatable element having at least one through hole;
a reflection object arranged at one side of the rotatable element; and
a control chip arranged at the other side of the rotatable element, the control chip comprising:
a light source configured to emit light toward the rotatable element, wherein when the rotatable element is rotated to a predetermined position, emitted light of the light source goes through the at least one through hole and projects on the reflection object;
an optical sensor configured to convert reflected light from the reflection object to electrical signals; and
a digital signal processor configured to position the rotatable element according to the electrical signals.

10. The optical structure as claimed in claim 9, wherein when the rotatable element is rotated to the predetermined position, the at least one through hole is right above the light source.

11. The optical structure as claimed in claim 9, wherein when the rotatable element is rotated to the predetermined position, the at least one through hole is between the light source and the optical sensor.

12. The optical structure as claimed in claim 9, wherein the digital signal processor is configured to position the rotatable element by comparing a magnitude of the electrical signals with a threshold.

13. The optical structure as claimed in claim 9, wherein the rotatable element has multiple through holes arranged with a predetermined relative distance from one another.

14. The optical structure as claimed in claim 13, wherein the digital signal processor is configured to position the rotatable element according to a number of variation times of a magnitude of the electrical signals.

15. The optical structure as claimed in claim 9, wherein the optical sensor is not configured to receive the reflected light via the at least one through hole.

16. The optical structure as claimed in claim 9, wherein the emitted light goes through a first through hole, and the reflected light goes through a second through hole which is different from the first through hole.

17. The optical structure as claimed in claim 9, wherein the emitted light and the reflected light go through an identical through hole.

18. The optical structure as claimed in claim 9, wherein the control chip is further configured to
receive a correct time signal, and
control the rotatable element to rotate to a calibration position according to the correct time signal.

19. The optical structure as claimed in claim 18, wherein the digital signal processor is further configured to identify whether an amplitude of the electrical signals exceed a threshold after the rotatable element is rotated to the calibration position to identify whether the calibration position is identical to the predetermined position.

20. The optical structure as claimed in claim 19, wherein the when the amplitude of the electrical signals does not exceed the threshold, the digital signal processor is further configured to continuously rotate the rotatable element and count a time interval to a next time at which the amplitude exceeds the threshold.
